(19) United States
(12) Patent Application Publication
(10) Pub. No.: US 2016/0339644 A1
(43) Pub. Date: Nov. 24, 2016

(54) THREE-DIMENSIONAL SHAPING APPARATUS AND LAMINATION SHAPING METHOD

(71) Applicant: CANON KABUSHIKI KAISHA, Tokyo (JP)

(72) Inventors: Ikuo Sobue, Kawasaki-shi (JP); Shigeki Sakurai, Yokohama-shi (JP); Noriyuki Suzuki, Tokyo (JP)

(21) Appl. No.: 15/156,760

(22) Filed: May 17, 2016

(30) Foreign Application Priority Data
May 22, 2015 (JP) 2015-104681

(51) Int. Cl. B29C 67/00

(52) U.S. Cl. CPC B29C 67/0088; B29C 67/0081; B29C 67/0096; B33Y 10/00

(57) ABSTRACT

Before forming a shaped object, processing in which a calibration marker formed from a shaping material is formed by an imaging forming unit and the calibration marker is laminated on a stage via a transfer member is performed. The calibration marker laminated on the stage is detected by a sensor, and image distortion of the calibration marker laminated on the stage is measured based on this detection result. When the shaped object is formed, correction to reduce the image distortion is performed on slice image data provided to the image forming unit, based on the image distortion measured in advance.

### BACKGROUND OF THE INVENTION

1. Field of the Invention

The present invention relates to a three-dimensional shaping apparatus.

2. Description of the Related Art

Three-dimensional shaping apparatuses which form three-dimensional shaped objects by laminating many layers are attracting attention. This type of lamination shaping technique is referred to as “additive manufacturing (AM)”, “three-dimensional printing”, “rapid prototyping” and the like. For the lamination shaping technique, various shaping methods have been proposed. In Japanese Patent Application Laid-Open No. H10-224581 and Japanese Patent Application Laid-Open No. 2003-053846, for example, a shaping method applying an electrophotographic process is disclosed, and in US Patent Application Publication No. 2009/0060386 (Description), a laser sintering method is disclosed.

### SUMMARY OF THE INVENTION

In a three-dimensional shaping apparatus, the shape accuracy of a cross-sectional image of each layer (image forming accuracy) and the positional accuracy when each layer is laminated (lamination accuracy) have a great influence on the quality of the final shaped object. These issues are especially critical in the case of a lamination method of independently forming an image of each layer and sequentially laminating these images, such as the case of the apparatus disclosed in Japanese Patent Application Laid-Open No. H10-224581 or Japanese Patent Application Laid-Open No. 2003-053846. However, in the apparatuses disclosed in Japanese Patent Application Laid-Open No. H10-224581 and Japanese Patent Application Laid-Open No. 2003-053846, distortion of the images and dispersion of image positions are not considered, therefore the image forming accuracy and the lamination accuracy cannot be guaranteed.

US Patent Application Publication No. 2009/0060386 (Description) discloses a positional calibration method for a laser sintering type apparatus, where the center reference of an image is determined by scanning a calibration plate before starting the shaping. This method, however, simply aligns the drawing position of the image to the center of the stage, and does not correct distortion of the image itself. Furthermore, this method cannot be applied to a lamination method of independently forming an image of each layer, and sequentially laminating these images, such as the lamination methods disclosed in Japanese Patent Application Laid-Open No. H10-224581 and Japanese Patent Application Laid-Open No. 2003-053846.

With the foregoing in view, it is an object of the present invention to provide a technique for improving the quality and accuracy of a shaped object in a three-dimensional shaping apparatus, which independently forms an image of each layer and sequentially laminates these images to acquire a three-dimensional shaped object.

The present invention in its first aspect provides a three-dimensional shaping apparatus, comprising: an image forming unit configured to form a material image formed from a shaping material based on input image data; a transfer member to which the material image formed by the image forming unit is transferred and which is configured to convey the material image; and a stage on which the material image conveyed by the transfer member is laminated, the three-dimensional shaping apparatus comprising: a marker generation unit configured to generate image data of a calibration marker; a control unit configured to input the generated image data of the calibration marker to the image forming unit; a first detection unit configured to detect a position of the calibration marker, which is formed by the image forming unit based on the image data of the calibration marker and laminated on the stage; and an image distortion measurement unit configured to measure image distortion of the calibration marker laminated on the stage, based on the detection result from the first detection unit.

The present invention in its second aspect provides a three-dimensional shaping apparatus, comprising: an image forming unit configured to form a material image formed from a shaping material based on input image data; a transfer member to which the material image formed by the image forming unit is transferred and which is configured to convey the material image; and a stage on which the material image conveyed by the transfer member is laminated, the three-dimensional shaping apparatus comprising: a control unit configured to generate slice image data including a slice image of a shaping target object and a registration marker, and to input the slice image data to the image forming unit; a second detection unit configured to detect the registration marker, which are formed by the image forming unit based on the slice image data and are included in the material image transferred to the transfer member; a position measurement unit configured to measure a positional shift of the material image on the transfer member based on the detection result from the second detection unit; and an adjustment unit configured to adjust a position of the stage based on the positional shift measured by the position measurement unit.

The present invention in its third aspect provides a lamination shaping method for shaping a three-dimensional object by forming a material image formed from a shaping material based on image data and laminating the material image on a stage, the lamination shaping method comprising the steps of: forming a calibration marker formed from the shaping material; laminating the calibration marker on the stage; detecting a position of the calibration marker laminated on the stage; and acquiring image distortion information on image distortion generated in the material image based on the position of the calibration marker.

The present invention in its fourth aspect provides a lamination shaping method for forming a three-dimensional object by forming a material image formed from a shaping material and laminating the material image on a stage, the lamination shaping method comprising the steps of: generating slice image data including a slice image of a shaping target object and a registration marker; forming the material image based on the slice image data; and detecting a position of the registration marker included in the material image and adjusting a relative position between the material image and the stage.

According to the present invention, the quality and accuracy of a shaped object can be improved in a three-dimensional shaping apparatus, which independently forms an image of each layer and sequentially laminates these images to acquire a three-dimensional shaped object.

Further features of the present invention will become apparent from the following description of exemplary embodiments with reference to the attached drawings.

### BRIEF DESCRIPTION OF THE DRAWINGS

FIG. 1 is a schematic diagram depicting a configuration of a three-dimensional shaping apparatus according to Embodiment 1;

FIG. 2 is a circuit block diagram of a shaping controller;

FIGS. 3A to 3C are diagrams depicting calibration markers and an image distortion;

FIG. 4 is a functional block diagram related to calibration and registration;

FIGS. 5A and 5B are flow charts depicting calibration and image distortion correction;

FIGS. 6A to 6C are conceptual diagrams of image distortion correction;

FIG. 7 is a conceptional diagram of registration transfer marker detection;

FIG. 8 is a schematic diagram depicting a configuration of a three-dimensional shaping apparatus according to Embodiment 2;

FIG. 9 is a schematic diagram depicting another configuration of the three-dimensional shaping apparatus according to Embodiment 2;

FIG. 10 is a schematic diagram depicting a configuration of a three-dimensional shaping apparatus according to Embodiment 3; and

FIG. 11 is a diagram depicting calibration markers of Embodiment 3.

### DESCRIPTION OF THE EMBODIMENTS

Embodiments of the present invention will now be described with reference to the drawings. Dimensions, materials, shapes and relative positions of components, the procedures of various controls, control parameters, target values and the like, described in the following embodiments, are not intended to limit the scope of the present invention unless otherwise specified.

### Embodiment 1

### Configuration of Three-Dimensional Shaping Apparatus

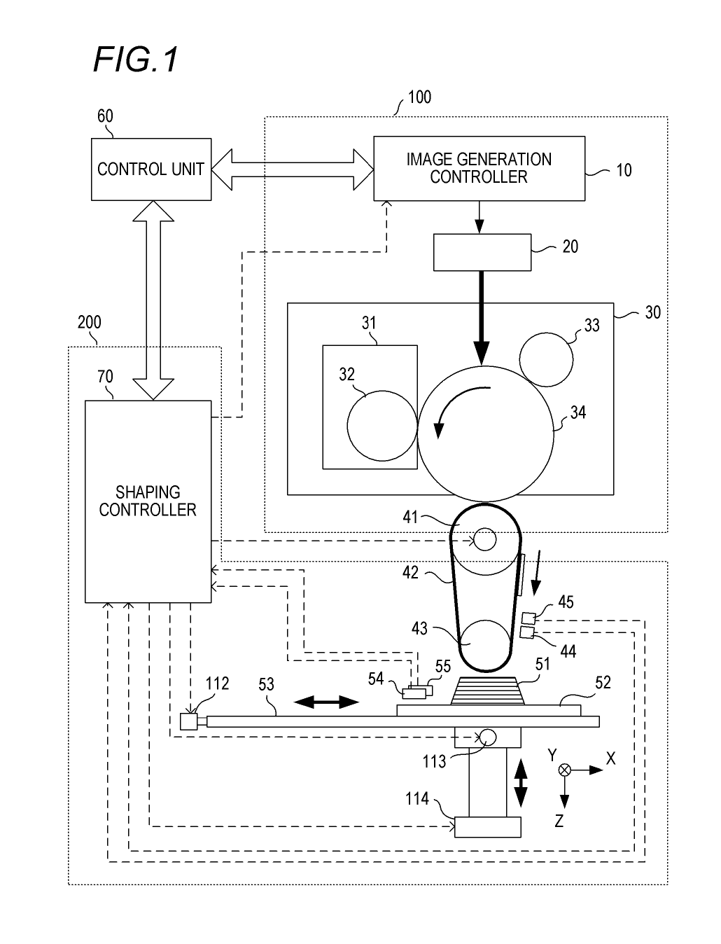

A configuration of a three-dimensional shaping apparatus according to Embodiment 1 of the present invention will be described with reference to FIG. 1. FIG. 1 is a schematic diagram depicting a configuration of the three-dimensional shaping apparatus according to Embodiment 1.

The three-dimensional shaping apparatus is an apparatus that forms a three-dimensional shaped object by laminating a shaping material according to the cross-sectional information of a shaping target object. This apparatus is also called an “additive manufacturing (AM) system”, “3-D printing” or a “rapid prototyping (RP) system”.

The three-dimensional shaping apparatus of this embodiment has an image forming unit 100, a shaping unit 200, and a control unit 60. The image forming unit 100 is a component to form one layer of an image formed from a shaping material, based on the slice image data of each layer. The image forming unit 100 includes an image generation controller 10, a laser scanner (exposure device) 20, a process cartridge 30 and a transfer roller 41. The shaping unit 200 is a component to form a three-dimensional shaped object having a three-dimensional structure by sequentially laminating and fixing a plurality of layers of images formed by the image forming unit 100. The shaping unit 200 includes a shaping controller 70, a transfer member 42, a counter member (heater roller) 43, a stage 52, a stage guide 53, a plurality of motors 111 to 114, and a plurality of sensors 44, 45, 54 and 55. The control unit 60 is a component to perform processing to generate a plurality of layers of slice image data (cross-sectional data) from the three-dimensional shape data of the shaping target object, and controls each component of the three-dimensional shaping apparatus and the like.

### (Control Unit)

The control unit 60 has a function of generating the slice image data for lamination shaping from the three-dimensional shape data of the shaping target object, a function of outputting the slice image data of each layer to the image generation controller 10, and a function of managing the lamination shaping step among other functions. The control unit 60 can be constructed by installing programs that have these functions on a personal computer or on an embedded computer, for example. For the three-dimensional shape data, data can be created by a three-dimensional CAD, a three-dimensional modeler, a three-dimensional scanner or the like. The format of the three-dimensional shape data is not especially limited, but polygonal data, such as stereolithography (STL), for example, can be used. For the format of the slice image data, multi-value image data (each value represents a type of material) or multi-plane image data (each plane corresponds to a type of material) can be used, for example.

### (Image Forming Unit)

The image generation controller 10 has a function of controlling the image forming process in the image forming unit 100, based on the slice image data input from the control unit 60, and control signals input from the shaping controller 70 and the like. In concrete terms, the image generation controller 10 performs resolution conversion and decoding processing of the slice image data, and controls the image writing start position and the timing by the laser scanner 20. The image generation controller 10 may have a function similar to a printer controller, which is embedded in a standard laser printer (2-D printer).

The image forming unit 100 is a unit that generates one layer of an image formed from a shaping material, using an electrophotographic process. The electrophotographic process is a method of forming a desired image through a series of processes of charging a photoreceptor, forming a latent image by exposure, and forming an image by adhering developer particles to a latent image. The three-dimensional shaping apparatus uses particles formed from a shaping material instead of toner, as the developer, but the basic principle of the electrophotographic process is essentially the same as that of a 2-D printer.

The photosensitive drum 34 is an image bearing member having such a photoreceptor layer as an organic photoreceptor and an amorphous silicon photoreceptor. A primary charging roller 33 is a charging device to uniformly charge a photoreceptor layer of the photosensitive drum 34. The laser scanner 20 is an exposure device that scans the photosensitive drum 34 by laser light according to the image signals provided from the image generation controller 10, and draws a latent image. A shaping material supply unit 31 is a device that stores and supplies a shaping material that is used as the developer. A development roller 32 is a developing assembly that supplies the shaping material to the electrostatic latent image on the photosensitive drum 34. A transfer roller 41 is a transfer device that transfers the image of the shaping material formed on the photosensitive drum 34 onto a transfer member (transfer belt) 42. A cleaning device (not illustrated) for cleaning the surface of the photosensitive drum 34 may be disposed downstream of a transfer nip between the photosensitive drum 34 and the transfer roller 41. In this embodiment, the photosensitive drum 34, the primary charging roller 33, the shaping material supply unit 31 and the development roller 32 are integrated as a process cartridge 30, so that replacement is easier.

For the shaping material, various materials can be selected according to the intended use, function and purpose of the shaped object to be created. In this description, a material constituting the shaped object (structure) is called a “structure material”, and a material constituting a support member (e.g. a post that supports an overhanging portion from the bottom) for supporting a shaped object during the lamination process, is called a “support material”. If it is unnecessary to make this distinction, then the simple term “shaping material” is used. For the structure material, a thermoplastic resin, such as polyethylene (PE), polypropylene (PP), ABS and polystyrene (PS) can be used. For the support material, a material having thermoplasticity and water solubility is preferable, since it is easy to remove from a structure. For the support material, glucide, polylactic acid (PLA), polyvinyl alcohol (PVA) or polyethylene glycol (PEG), for example, can be used.

### (Shaping Unit)

The shaping controller 70 has a function of performing mechatronic control of the three-dimensional shaping apparatus. A driving system includes a transfer roller motor 111 that rotates the transfer roller 41, and a stage driving X motor 112, a stage driving Y motor 113 and a stage driving Z motor 114 which move the stage 52 in three axis directions. A sensing system includes a material end detection sensor 44 which is used for online registration, a material end detection sensor 45 which is used for offline calibration, and a material left end sensor 54 and a material right end sensor 55. The roles of these sensors, online registration and offline calibration will be described in detail later.

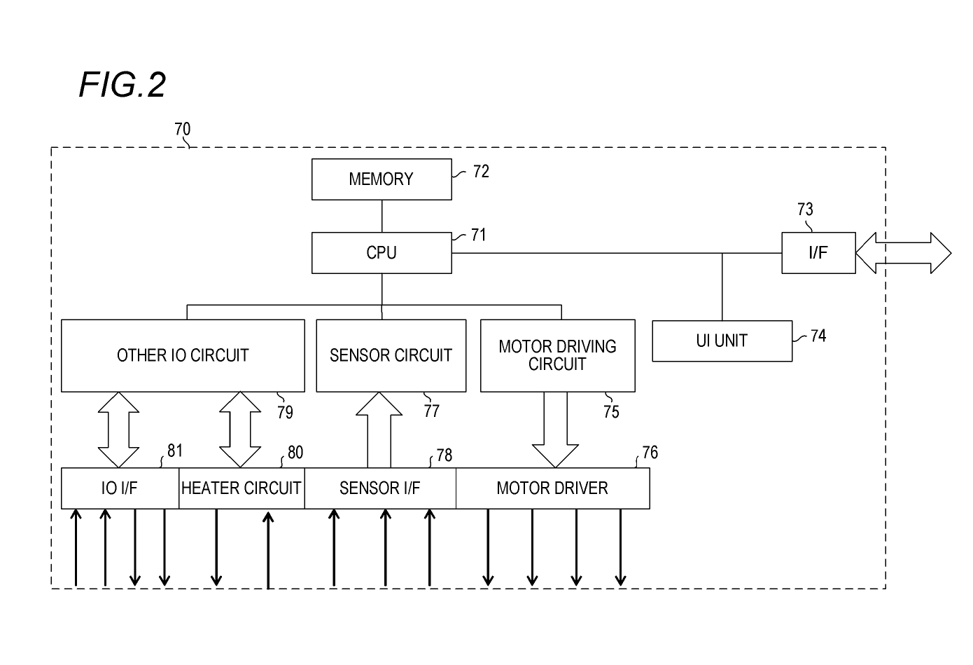

FIG. 2 shows an example of the circuit blocks of the shaping controller 70. The shaping controller 70 includes a CPU 71, a memory 72, an interface 73, a UI unit 74, a motor driving circuit 75, a motor driver 76, a sensor circuit 77, a sensor interface 78, other input/output (I/O) circuits 79, a heater circuit 80, and an I/O interface 81. The transfer roller motor 111, the stage driving X motor 112, the stage driving Y motor 113 and the stage driving Z motor 114 are connected to the motor driver 76. The material end detection sensor 44, the material end detection sensor 45, the material left end sensor 54 and the material right end sensor 55 are connected to the sensor interface 78. A heater and thermocouple in the heater roller 43 are connected to the heater circuit 80. A cover open detection switch of the three-dimensional shaping apparatus, a home position sensor of the stage 52 and the like (not illustrated) are connected to the I/O interface 81.

The transfer member 42 is a conveyance member that bears an image of the shaping material formed by the image forming unit 100, and conveys (transports or carries) the image to the stage 52 (lamination nip). The transfer member 42 is constituted by an endless belt made of resin, polyimide or the like. The counter member 43 is a heating lamination device which includes a heater, that melts the shaping material image on the transfer member 42, and laminates the image on the shaped object on the stage 52. Here a roller (heater roller 43), for conveying the transfer member 42, is used as the counter member 43, but the present invention is not limited to this configuration. It is sufficient if the counter member 43 has a function to press the melted shaping material image against the shaped object on the stage 52, and the heating unit that melts the shaping material image may be disposed separately from the counter member 43. The stage 52 is a member that holds the shaped object during lamination, and can be moved in three axis directions (X, Y and Z) by the stage guide 53.

### (Operation of Three-Dimensional Shaping Apparatus)

The basic operation of the three-dimensional shaping apparatus to form a shaped object will now be described.

The control unit 60 generates the slice image data of each layer. For example, the control unit 60 generates a slice image of each layer by slicing the shaping target object at a predetermined pitch (e.g. several μm to slightly more than a ten μm thickness) based on the three-dimensional shape data of the shaping target object. Then the control unit 60 attaches a registration marker (described in detail later) to the slice image of each layer, whereby the slice image data of each layer is generated. The slice image of each layer need not always be generated by the control unit 60, for the slice image data may be generated by acquiring the slice image generated outside the control unit 60 as well, and attaching the registration marker thereon. The slice image data is sequentially input to the image generation controller 10 from the slice image data of the lowest layer. The image generation controller 10 controls the laser emission and scanning of the laser scanner 20 according to the input slice image data.

In the image forming unit 100, the surface of the photosensitive drum 34 is uniformly charged by the primary charging roller 33. When the surface of the photosensitive drum 34 is exposed to laser light from the laser scanner 20, the exposed portion is destaticized. The shaping material charged with developing bias is supplied to the destaticized portion by the development roller 32, and one layer of an image formed from the shaping material (hereafter called “material image”) is formed on the surface of the photosensitive drum 34. This material image is transferred onto the transfer member 42 by the transfer roller 41.

The transfer member 42 rotates while bearing the material image, and conveys the material image to the lamination position. On the other hand, the shaping controller 70 controls the stage 52 so that the stage 52 (or a semi-shaped product on the stage 52) enters the lamination position at the same timing and same speed with the material image. Then the stage 52 and the transfer member 42 are heated by the heater roller 43 while moving in sync, whereby the material image is heat-welded onto the stage 52 (or the upper surface of the semi-shaped product on the stage 52). Each time the material image is layered, the shaping controller 70 lowers the stage 52 in the Z direction by a thickness of one layer, and waits for the lamination of the next layer.

This operation of image formation and lamination is repeated for the number of images of the slice image data, whereby the target three-dimensional shaped object is formed on the stage 52.

In this description, an object to be formed by the three-dimensional shaping apparatus (that is, an object represented by the three-dimensional shape data output to the three-dimensional shaping apparatus) is called a “shaping target object”, and an object formed (output) by the three-dimensional shaping apparatus is called a “shaped object”. In the case when the shaped object includes a support member, the portion of the shaped object, excluding the support member, is called a “structure”. Digital data that includes one slice of data, which is acquired by slicing the three-dimensional shape data of the shaping target object and the data of a registration marker, is called “slice image data”. One layer of an image formed from a shaping material, which is formed by the image forming unit based on the slice image data, is called a “material image”.

### (Problem of Lamination Shaping)

In the case of a three-dimensional shaping apparatus which forms a shaped object by laminating many images (lamination type), as in this embodiment, the shape accuracy of the material image and the positional accuracy upon lamination determines the quality of the final shaped object. For example, distortion may be generated in the material image because of problems in the scanning accuracy of exposure and the dimensional accuracy of the photosensitive drum and transfer roller. If such image distortion accumulates, the dimensions and the shape of the final shaped object are affected in a significant way. Further, if the position of the material image of each layer upon being laminated on the shaped object on the stage 52 disperses, the side face of the final shaped object becomes uneven, and a smooth surface cannot be created. This is a problem unique to the lamination type three-dimensional shaping apparatus, which forms one final shaped object by laminating several hundred to several tens of thousands of images.

Therefore according to this embodiment, in order to guarantee the shape accuracy of the material image of each layer, the image distortion generated in the image forming unit 100 is measured before forming the shaped object (this is called “offline calibration”), and the image distortion correction is performed for the slice image data of each layer when the image is formed. Further, in order to guarantee the positional accuracy upon lamination, the position of the material image of each layer on the transfer member is measured, and the positions of the material image and the shaped object on the stage 52 are aligned upon lamination (this is called “online registration”). The offline calibration, the image distortion correction, and the online registration will now be described in detail.

### (Offline Calibration)

Now the offline calibration performed before generating the shaped object will be described. In the offline calibration, the calibration markers are formed on the stage 52 in the same procedure as the image formation and lamination described above, and the image distortion is measured based on the positional shift of the markers. The offline calibration may be performed not only before generating the shaped object, but also during the intervals of the lamination of the material images.

In the following description, the image data for a calibration marker input to the image generation controller 10 is called “calibration marker data”. The calibration marker data is stored in the memory of the control unit 60, and is read when the offline calibration is performed. An image formed from a shaping material, which is formed based on the calibration marker data, is called a “calibration marker” or “marker”. Further, a marker transferred from the photosensitive drum 34 to the transfer member 42 (that is, a marker on the transfer member 42) is called a “calibration transfer marker”, and a marker transferred onto the stage 52 is called a “calibration lamination marker”. The name of a marker is different depending on the location of the marker, since an image distortion of a marker can change in the process when the marker is in-transfer, and a marker is detected using a different sensor depending on the marker location, therefore it is more convenient to identify a marker by its location. In a context where the location of the marker need not be identified, a term “calibration marker” or “marker” is used.

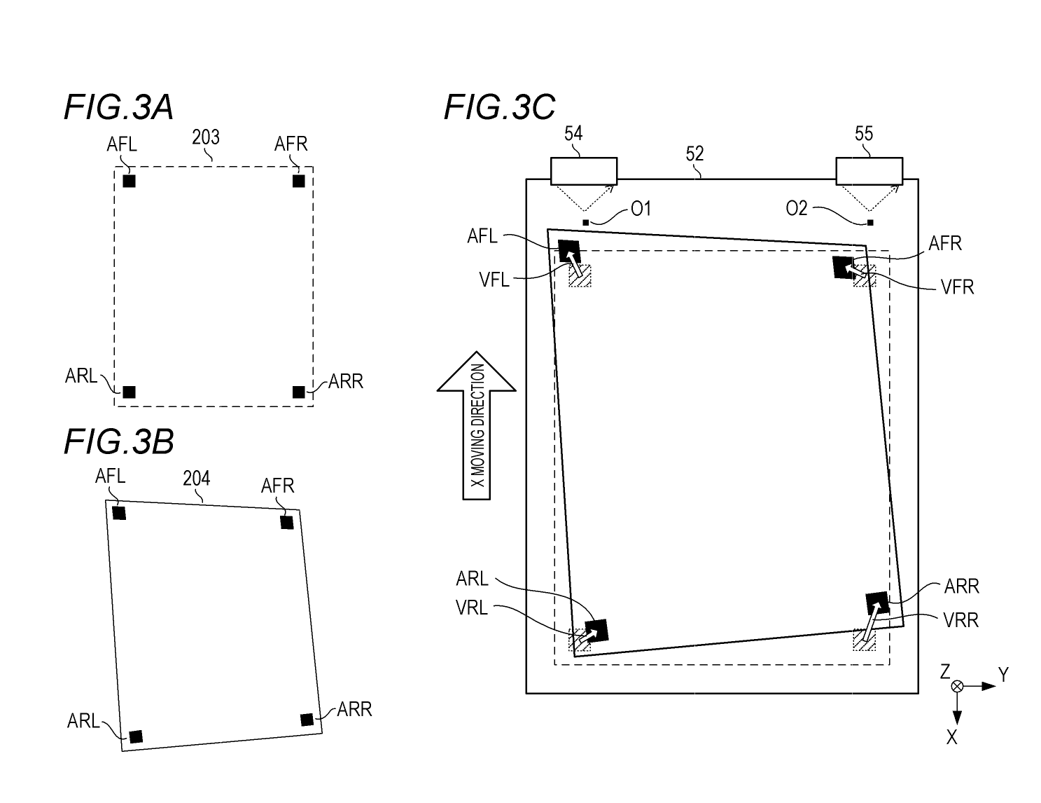

FIG. 3A shows an example of calibration markers (in a state free of image distortion) used for this embodiment. The rectangle indicated by the dotted line in the calibration chart 203 corresponds to a 200 mm×300 mm image forming range. The size of this image forming range is the same as the shaping area (maximum area where shaping is possible) on the stage 52. A front left end calibration marker AFL, a front right end calibration marker AFR, a rear left end calibration marker ARL and a rear right end calibration marker ARR are disposed at the four corners of the image forming range. Each marker AFL, AFR, ARL and ARR is a 5 mm x 5 mm square image, and is generated at the center of a 10 mm×10 mm area at a corner of the image forming range.

FIG. 3B shows an example of a calibration lamination marker 204 transferred onto the stage 52. In the state shown in FIG. 3B, the positions of the markers AFL, AFR, ARL and ARR at the four corners and the relative positions among the markers have changed because of the image distortion generated in the process of image formation and/or lamination.

FIG. 3C is a schematic diagram depicting the stage, the calibration lamination markers and the sensors. An origin O1 and an origin O2, to be the detection references of the sensors, are indicated on the stage 52. The origins O1 and O2 are dimensional reference points for which high positional accuracy is demanded. As a result, it is preferable that the origins O1 and O2 are created by high precision printing, such as laser marking, or punching using high precision NC processing. The origins O1 and O2 also influence the detection accuracy of the sensors, hence in the case of the optical sensors used for this embodiment, a printing method or a processing method, which can maximize the contrast between the origins and their peripheral areas, is desirable. In this embodiment, the origins O1 and O2 are created by laser marking.

In an upper part of the stage 52, a material left end sensor 54 is disposed at a Y position corresponding to the origin O1, and a material right end sensor 55 is disposed at a Y position corresponding to the origin O2. The material left end sensor 54 is a sensor for detecting the positions of the front left end calibration marker AFL and the rear left end calibration marker ARL. The material right end sensor 55 is a sensor for detecting the positions of the front right end calibration marker AFR and the rear right end calibration marker ARR. The vectors VFL, VFR, VRL and VRR shown in FIG. 3C indicate the displacement (deformation vectors) of the markers AFL, AFR, ARL and ARR with respect to the positions of AFL, AFR, ARL and ARR in the state where image distortion is not generated. The offline calibration in this embodiment is processing of actually forming the calibration markers on the stage 52, and measuring the deformation vectors VFL, VFR, VRL and VRR generated by the image formation and lamination.

Normally the directions of the deformation vectors of the markers at the four corners are different. This is because the direction and degree of displacement differ depending on the position in the shaping area due to the influence of distortion of the transfer member 42, the alignment deviation of each roller shaft or the like. Therefore the calibration markers are required to acquire deformation vectors at a plurality of points in the shaping area. For example, at least two markers are disposed at distant positions in the shaping area on the stage, and a deformation vector at each position is detected (measured), and it is even better if the markers are disposed at the four corners of the rectangular shaping area, as in this embodiment. The calibration marker is not limited to the plurality of markers, but a frame shaped material image connecting AFL, AFR, ARL and ARR may be formed as a calibration marker, and deformation vectors may be measured at the corners of the frame. Thereby displacement generated at each marker position in the shaped area can be detected. If a hard belt material is used as the transfer member 42, the displacement generated at each position in the shaping area becomes relatively linear, hence the deformation vectors at positions other than the markers at the four corners can be determined by the linear interpolation of the deformation vectors acquired by the markers at the four corners. If the transfer member 42 has a flexibility that is partially cyclic or discontinuous, the number of calibration markers may be increased. For example, it is preferable that a plurality of markers are arrayed along the four sides of the shaping area.

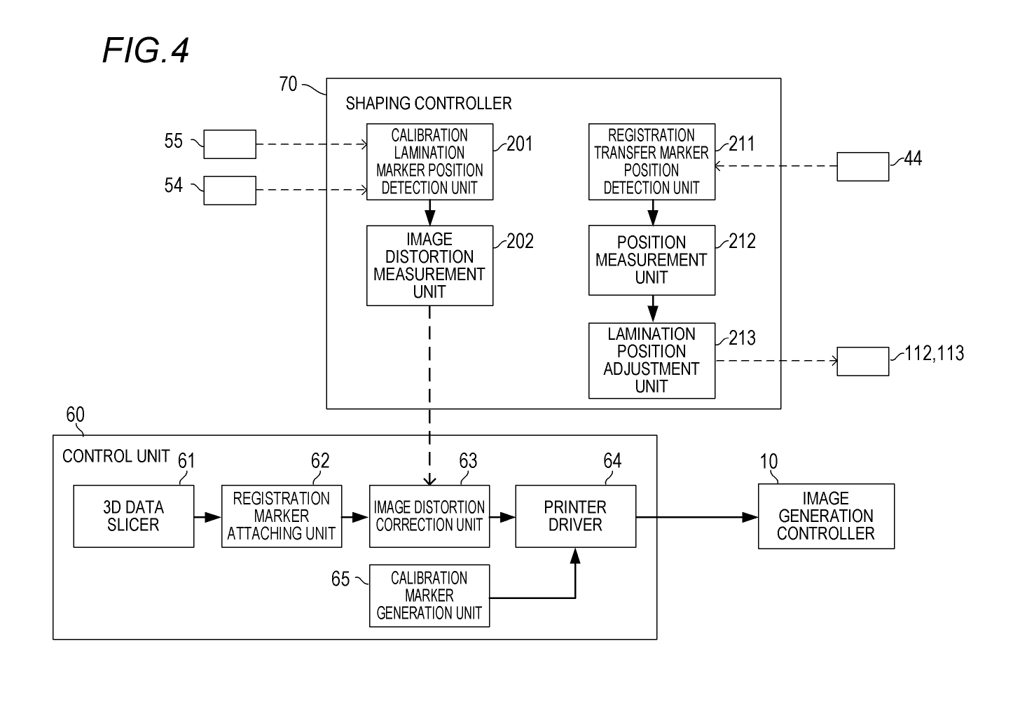

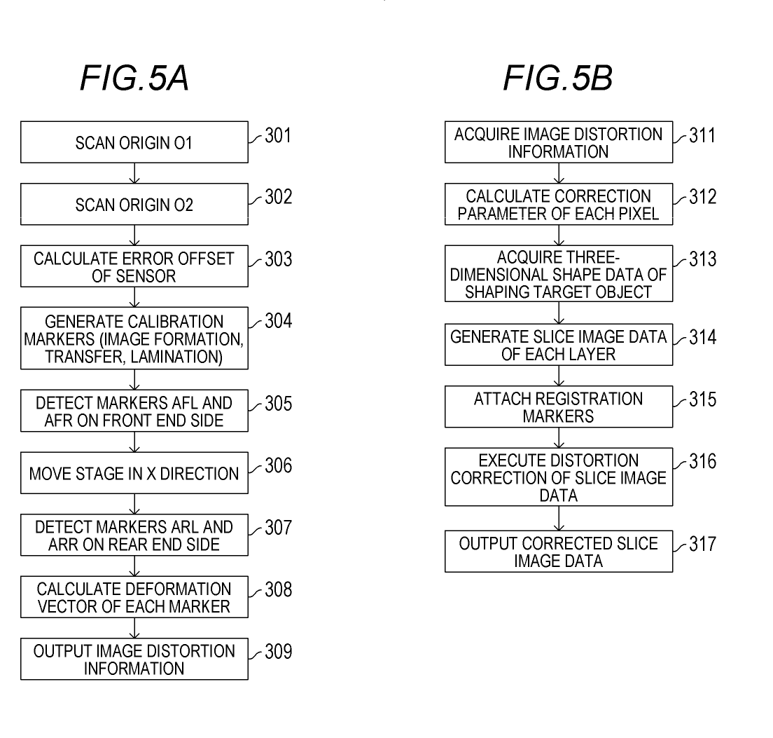

The offline calibration will be described in detail with reference to FIGS. 4 and 5A. FIG. 4 is a block diagram depicting the functions related to the offline calibration, and FIG. 5A is a processing flow chart of the offline calibration.

As shown in FIG. 4, the control unit 60 has a calibration marker generation unit 65 as a function related to the offline calibration. The shaping controller 70 has a calibration lamination marker position detection unit 201 and an image distortion measurement unit 202 as functions related to the offline calibration. The calibration lamination marker position detection unit 201 has a function of detecting the position of each marker AFL, AFR, ARL and ARR, based on the sensing results of the material left end sensor 54 and the material right end sensor 55. The image distortion measurement unit 202 has a function to determine the deformation vectors VFL, VFR, VRL and VRR of each marker.

The flow of the offline calibration by the shaping controller 70 will be described with reference to the flow chart in FIG. 5A.

In step 301, the shaping controller 70 monitors the output of the material left end sensor 54 while changing the XY positions of the stage 52 by controlling a stage driving X motor 112 and a stage driving Y motor 113. When the origin O1 is detected, the shaping controller 70 stores the XY positions of the stage 52 at this point as X=0 and Y=0. In the same manner, in step 302, the shaping controller 70 monitors the output of the material right end sensor 55 while changing the XY positions of the stage 52. In step 303, the shaping controller 70 stores the difference between the XY positions of the stage 52 when the origin O2 was detected and the XY positions of the stage 52 when the origin O1 was detected, as X=dx and Y=dy. This (dx, dy) is an error offset value representing the mounting errors of the material left end sensor 54 and the material right end sensor 55. If the mounting errors of the two sensors 54 and 55 are negligible (in other words, if it is regarded that dx=dy=0), then the processing in steps 302 and 303 may be omitted.

In step 304, the calibration marker generation unit 65 of the control unit 60 outputs the calibration marker data to the image generation controller 10, whereby the image forming unit 100 and the shaping unit 200 generate the calibration lamination markers. In concrete terms, the image forming unit 100 forms the calibration markers formed from the shaping material on the photosensitive drum 34 based on the calibration marker data, using the same process as forming the material image of the shaped object. The markers are transferred from the photosensitive drum 34 onto the transfer member 42, and are then conveyed to the shaping unit 200 as calibration transfer markers. When the material end detection sensor 45 detects the front end of the calibration transfer markers, the shaping controller 70 controls the stage 52 so that the stage 52 advances to the lamination position at the same timing as the calibration transfer markers. Then the calibration transfer markers are transferred onto the stage 52 by the heater roller 43, whereby the calibration lamination markers are acquired. The calibration lamination markers AFL, AFR, ARL and ARR include information on the image distortion which is generated in a series of processes, such as exposure, development, transfer and lamination, as shown in FIG. 3B.

In step 305, the shaping controller 70 monitors the output of the material left end sensor 54 and the material right end sensor 55, while changing the XY positions of the stage 52 by controlling the stage driving X motor 112 and the stage driving Y motor 113. The XY positions of the marker AFL detected by the material left end sensor 54 and the XY positions of the marker AFR detected by the material right end sensor 55 are stored in a calibration lamination marker position detection unit 201. In step 306, the shaping controller 70 controls the stage driving X motor 112, and moves the stage 52 to the positions of the calibration lamination markers ARL and ARR at the rear end. In step 307, the shaping controller 70 monitors the output of the material left end sensor 54 and the material right end sensor 55 while changing the XY positions of the stage 52 by controlling the stage driving X motor 112 and the stage driving Y motor 113. The XY positions of the marker ARL detected by the material left end sensor 54 and the XY positions of the marker ARR detected by the material right end sensor 55 are stored in the calibration lamination marker position detection unit 201.

In step 308, the image distortion measurement unit 202 calculates the XY positions of each marker AFL, AFR, ARL and ARR in the state without the image distortion (these XY positions are called “normal positions”), based on the XY positions of the origin O1. Then, based on the difference between the normal position of each marker and the detected position of each marker detected in steps 305 and 307, the image distortion measurement unit 202 calculates the deformation vectors VFL, VFR, VRL and VRR representing the displacement amount and direction of the displacement of each marker. If there is an error offset amount (dx, dy) between the two sensors 54 and 55, the error offset amount (dx, dy) is considered when calculating the deformation vectors VFR and VRR.

In step 309, the shaping controller 70 sends the deformation vector of each marker to the control unit 60 as image distortion information on the image distortion generated in the material image in a period from the generation of the material image in the image forming unit to lamination on the stage.

### (Image Distortion Correction)

Image distortion correction, which is executed upon forming the material image, based on the image distortion information acquired in advance by the offline calibration, will now be described with reference to FIGS. 4 and 5B.

As shown in FIG. 4, the control unit 60 has a 3-D data slicer 61, a registration marker attaching unit 62, an image distortion correction unit 63, and a printer driver 64 as functions related to the slice image data generation and the image distortion correction. The operation of the control unit 60 upon forming an image will be described below with reference to the flow chart in FIG. 5B.

In step 311, image distortion information is acquired from the shaping controller 70. In step 312, the image distortion correction unit 63 calculates inverse vectors from the deformation vectors of the markers at the four corners, which are acquired as image distortion information, and linearly interpolates these inverse vectors, whereby a correction parameter for each pixel is calculated. The correction parameter is, for example, information to indicate the correspondence between the pixel coordinates in the image before correction and the pixel coordinates in the image after correction.

In step 313, the three-dimensional shape data of the shaping target object is read. In step 314, the 3-D data slicer 61 slices the three-dimensional shape of this shaping target object at a predetermined pitch (e.g. several μm to a slightly more than a ten μm thickness) based on the three-dimensional shape data, so as to generate a slice image of each layer. In step 315, the registration marker attaching unit 62 attaches the registration marker to the slice image of each layer, so as to generate slice image data (a registration marker will be described in detail later). Instead of steps 314 and 315, the slice image data of each layer may be generated by attaching the laminate of the registration marker to the three-dimensional shape data, which is read by the registration marker attaching unit 62, and then slicing the three-dimensional shape using the 3-D data slicer 61.

In step 316, the image distortion correction unit 63 corrects the distortion of the slice image data using the correction parameters determined in step 312. The distortion correction here is processing to provide distortion in the reverse direction to the slice image, so that the image distortion generated in the process from the image formation to lamination is reduced or eliminated. The distortion of the slice image data may also be corrected by correcting the distortion of the three-dimensional shape data before slicing, instead of correcting distortion of the data after slicing using the 3-D data slicer 61. In step 317, the printer driver 64 sends the corrected slice image data to the image generation controller 10.

If the slice image data is corrected based on the image distortion information acquired by the offline calibration, as described above, a material image with very little or no image distortion when laminated on the stage 52 can be formed, and the dimensional accuracy of the shaped object can be improved.

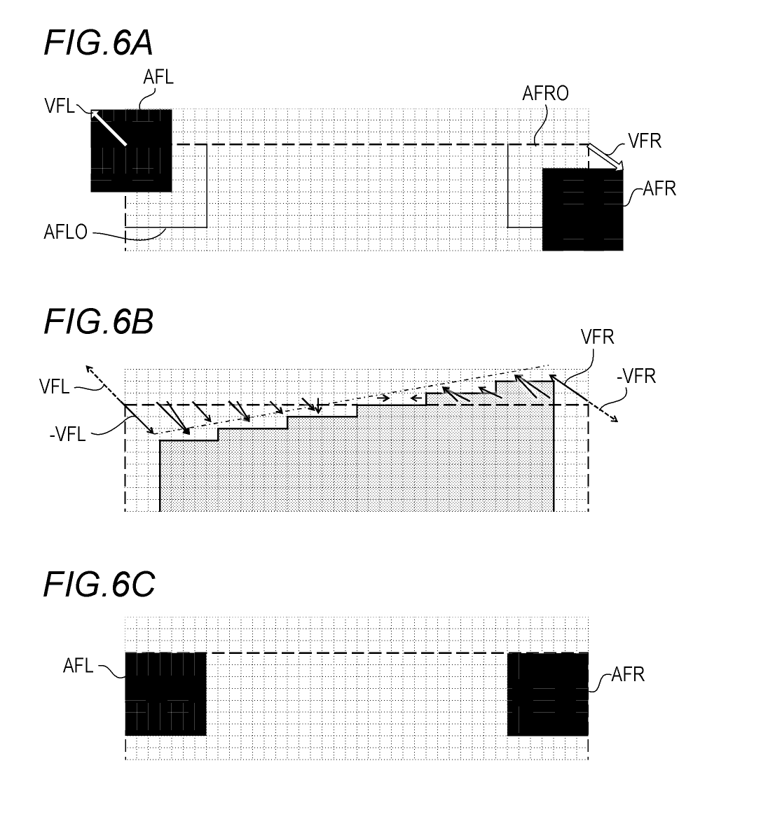

A concept of the image distortion correction will be described with reference to FIGS. 6A to 6C. In FIGS. 6A to 6C, only the correction of the pixels on the upper edge of the image will be shown to simplify description (the same correction is performed for all the pixels of the image in an actual correction).

The broken line in FIG. 6A indicates the shaping area on the stage 52, and the white squares AFLO and AFRO at the left and right of the shaping area indicate the normal positions of the calibration lamination markers in a state without image distortion. The black squares AFL and AFR indicate the positions where the calibration lamination markers were actually laminated when the offline calibration was performed. VFL and VFR indicate the deformation vectors of the markers AFL and AFR respectively. In the case of FIG. 6A, the image is stretched to the left and right, where the left side of the image moved forward from the normal position, and the right side of the image moved backward from the normal position.

FIG. 6B schematically shows the concept of the image distortion correction. The broken line indicates the shaping area on the stage 52, and the solid line virtually indicates the area of the slice image after correction. At the upper left end of the image, the pixel is moved by the inverse vector ₋VFL of the deformation vector VFL. At the upper right end of the image, the pixel is moved by the inverse vector ₋VFR of the deformation vector VFR. In the positions between the upper left end and the upper right end, the pixels are moved and skipped based on the linear interpolation between the inverse vectors ₋VFL and ₋VFR. The slice image used for the lamination shaping is a binary image (whether material particles are present or not), hence each pixel cannot have an intermediate gradation. As a consequence, correction of the image distortion (movement of pixels) is performed in pixel units, and the edge of the image after correction becomes terraced, as shown in FIG. 6B. Skipping a pixel is also simple, that is, when two pixels move into a same pixel, one of the pixels is deleted, as shown in FIG. 6B.

FIG. 6C shows an image formed on the stage 52 when the image formation and lamination are performed using the corrected slice image data indicated by the solid line in FIG. 6B. The calibration lamination markers AFL and AFR are laminated at the normal positions, and the front ends thereof become straight lines without inclination. Thereby lamination without image distortion can be implemented. Although not clearly shown here, the upper edge of the image is terraced, and pixels are partially inclined. The number of pixels of the upper edge of the image is low, and an actual grid (one pixel) is slightly stretched although the width of the image is a normal width. In the case of a 1% expansion or contraction, 50 μm particles in one pixel expand or contract 0.5 μm, but this difference is so small that it is visually unrecognizable when the entire image is viewed.

### (Online Registration)

Online registration, which is performed when the material image is laminated, will now be described. In the online registration, a registration marker is inserted into the material image, and the material image is aligned at lamination based on the detected positions of these markers.

In the following description, the image data for a registration marker input to the image generation controller 10 is called “registration marker data”. An image formed from a shaping material, which is formed based on the registration marker data is called a “registration marker” or a “marker”. Further, a marker transferred from the photosensitive drum 34 to the transfer member 42 (that is, a marker on the transfer member 42) is called a “registration transfer marker”, and a marker transferred onto the stage 52 is called a “registration lamination marker”. The name of a marker is different depending on the location of the marker, since an image distortion of a marker can change in the process when the marker is in-transfer, and a marker is detected using a different sensor depending on the marker location, therefore it is more convenient to identify a marker by its location. In a context where the location of the marker need not be identified, a term “registration marker” or “marker” is used.

As shown in FIG. 4, the shaping controller 70 has a registration transfer marker position detection unit 211, a position measurement unit 212 and a lamination position adjustment unit 213 as the functions related to online registration.

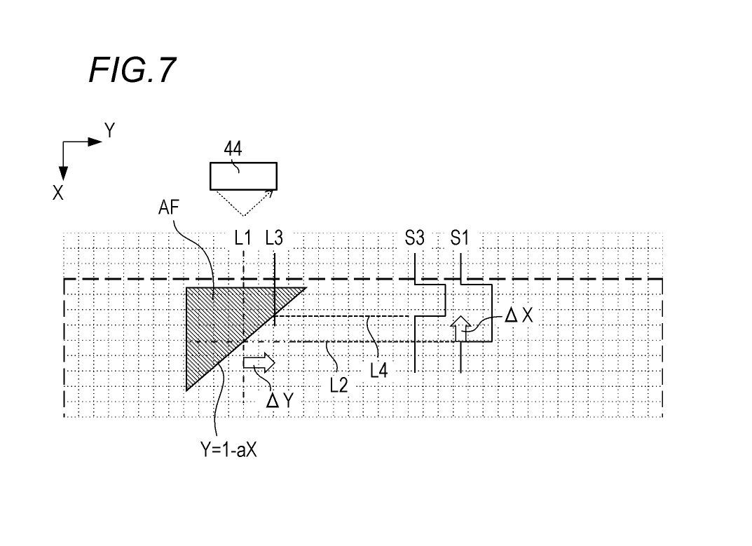

As described in step 315 in FIG. 5B, the image of the registration marker for alignment is embedded in the slice image data of each layer. In this embodiment, a registration marker AF having a right-angled triangular shape is formed at a predetermined position (a position which does not overlap with the cross-section of the shaped object) in the shaping area as shown in FIG. 7.

The registration transfer marker position detection unit 211 detects the registration transfer markers AF on the transfer member 42 using the material end detection sensor 44. Then the position measurement unit 212 acquires the position in the X direction (front end position) and the positional shift amount in the Y direction of the material image from the detection result of the registration transfer markers AF. Here the X direction is the advancing direction of the transfer member 42, and the Y direction is the width direction (direction orthogonal to the advancing direction) of the transfer member 42. Based on the position of the material image in the X direction, the lamination position adjustment unit 213 controls the driving start timing of the stage driving X motor 112, and aligns the front ends of the shaped object on the stage 52 and the material image on the transfer member 42. The lamination position adjustment unit 213 also controls the stage driving Y motor 113, and aligns the left ends of the shaped object on the stage 52 and the material image on the transfer member 42 based on the positional shift amount of the material image in the Y direction. Thereby lamination dispersion of the semi-shaped object and the material image on the XY plane is cleared online, and high quality shaping becomes possible.

FIG. 7 is a conceptual diagram of the registration transfer marker detection on the transfer member. The registration transfer marker AF is formed at a predetermined position (a position which does not overlap with the cross-section of the shaped object) in the front end portion of the shaping area on the transfer member 42. The registration transfer marker AF of this embodiment is a right-angled triangular graphic having a first edge which is orthogonal to the advancing direction (X direction) of the transfer member 42, and a second edge which is diagonal with respect to the X direction.

The change amount of the hypotenuse of the right-angled triangle is given by

Y=1−aX

Here a is a slope of the hypotenuse, and the length of one side of the triangle is 1.

When a side at the left of the registration transfer marker AF is Y=0 and the normal position is Y=0.5, then the shift amount ΔY can be given by

ΔY=Y−0.5=(1−aX)−0.5=0.5−aX

If the angle of the hypotenuse is 45°, then a=1, and ΔY=0 when X=0.5, ΔY=0.5 when X=0, and ΔY=−0.5 when X=1. The range of X is 0<X<1.

The material end detection sensor 44 detects a first edge and a second edge of the registration transfer marker AF. L1 indicates a detection line of the material end detection sensor 44 when the registration transfer marker AF on the transfer member 42 passes the normal position. In other words, the state when the material end detection sensor 44 passes the line L1 becomes the reference (shift amount ΔY=0). S1 indicates the output signal of the material end detection sensor 44 when the material end detection sensor 44 passes the line L1. If the first edge of the registration transfer marker AF is detected, the signal changes from low level to high level. If the second edge L2 is detected, the signal changes from high level to low level.

If the transfer member 42 shifts from the reference position to the left by ΔY here, the material end detection sensor 44 passes the line L3. S3 indicates the output signal of the material end detection sensor 44 when the material end sensor 44 passes the line L3. When the first edge of the registration transfer marker AF is detected, the signal changes from low level to high level. When the second edge L4 is detected, the signal changes from high level to low level.

Therefore the position in the X direction (front end position) is recognized by the rise timing of the output signal S3 of the material end detection sensor 44. Further, from the high level period (difference between the first edge detection timing and the second edge detection timing) of the output signal S3 and expression Y=1−aX, the positional shift amount ΔY of the registration transfer marker in the Y direction with respect to the normal position can be determined. In this way, the positions in two directions (X and Y directions) can be detected by one registration transfer marker and one material end detection sensor 44. This is advantageous in terms of cost because the configuration and processing are simplified, and is advantageous in terms of increasing speed of the position alignment in the two directions. The configuration of this embodiment is effective for lamination, since the transfer member 42 and the stage 52 can move at high-speed. However, if the positional shift in the Y direction is negligibly minimal, it is sufficient if only the position in the X direction can be detected, and a square marker having two side parallel in the Y direction and two sides parallel in the X direction can be used, for example.

According to the configuration of the three-dimensional shaping apparatus of this embodiment described above, the distortion of an image in the XY plane, generated in the process from the image formation to lamination, can be minimized by performing offline calibration and image distortion correction. Furthermore, the positional shift during lamination can be minimized by performed online registration. As a result, high quality shaped objects can be formed with high shape accuracy and dimensional accuracy.

An image distortion during image formation is generated by, for example, the distortion of the photosensitive drum 34, the distortion of the development roller 32, the alignment shift of each roller shift, the abrasion of each member and the like. Therefore, it is preferable that the execution timing of the offline calibration is at the beginning of each shaping job. If the image distortion is negligible, the offline calibration can be omitted.

### Embodiment 2

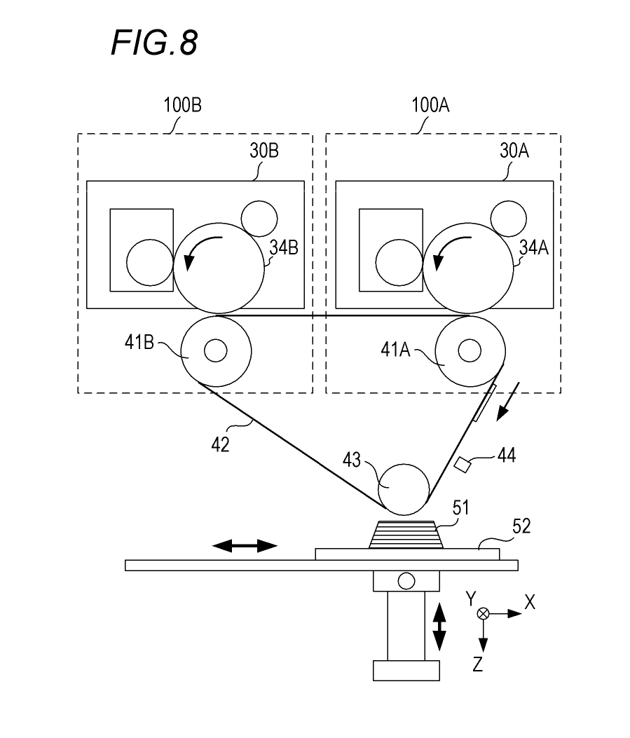

FIG. 8 is a diagram depicting a configuration of a three-dimensional shaping apparatus according to Embodiment 2 of the present invention. The difference from Embodiment 1 is that a plurality of image forming units are included. In the example of FIG. 8, the three-dimensional shaping apparatus has a first image forming unit 100A which includes a cartridge 30A, a photosensitive drum 34A and a transfer roller 41A, and a second image forming unit 100B which includes a cartridge 30B, a photosensitive drum 34B and a transfer roller 41B. According to this configuration, if the cartridge 30A contains a structure material and the cartridge 30B contains a support material, a shaped object having a support member formed from a material different from the structure (e.g. a material which makes removal from the structure easier) can be easily created. Further, if both cartridges 30A and 30B contain a same material, image formation can be performed using one image forming unit 100A, and when the material empties, the image formation can continue using the other image forming unit 100B which switches automatically from the image forming unit 100A. Further, if the cartridge 30A and the cartridge 30B contain materials of which colors and properties are different from each other, a colorful shaped object or a shaped object formed from a plurality of types of materials can be formed.

In the case of the three-dimensional shaping apparatus of this embodiment as well, shaping with high shape accuracy can be implemented by performing offline calibration and image distortion correction for each image forming unit. If image distortion generated in the image forming units 100A and 100B is small, in terms of scan accuracy at exposure, dimensional accuracy of the photosensitive drum and the like, then the image distortion information acquired by the offline calibration using either one of the image forming units 100A and 100B may be used for the image distortion correction upon forming a material image in both image forming units.

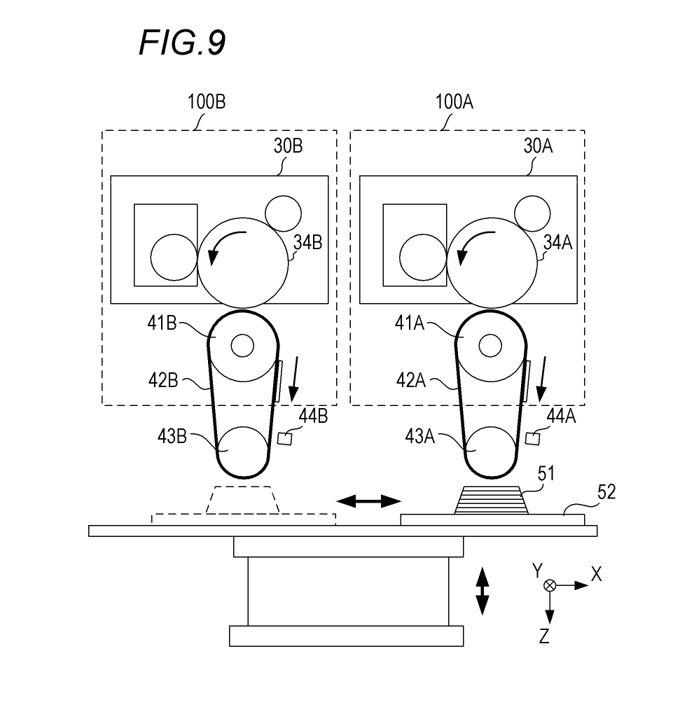

FIG. 9 is a modification of the apparatus in FIG. 8. In the three-dimensional shaping apparatus in FIG. 9, a transfer member (42A, 42B), a heater roller (43A, 43B) and a material end detection sensor (44A, 44B) are disposed in the image forming units 100A and 100B respectively.

In the case of this configuration, image distortion in the transfer member 42A and in the transfer member 42B are different, and the lamination timings thereof are also different, hence independent image distortion correction and registration are required. Therefore, the offline calibration is performed and image distortion is corrected for the image forming unit 100A and for the image forming unit 100B, respectively. When lamination is performed, the markers on the transfer member 42A and the markers on the transfer member 42B are read respectively using different sensors 44A and 44B, whereby the respective material images can be aligned independently.

### Embodiment 3

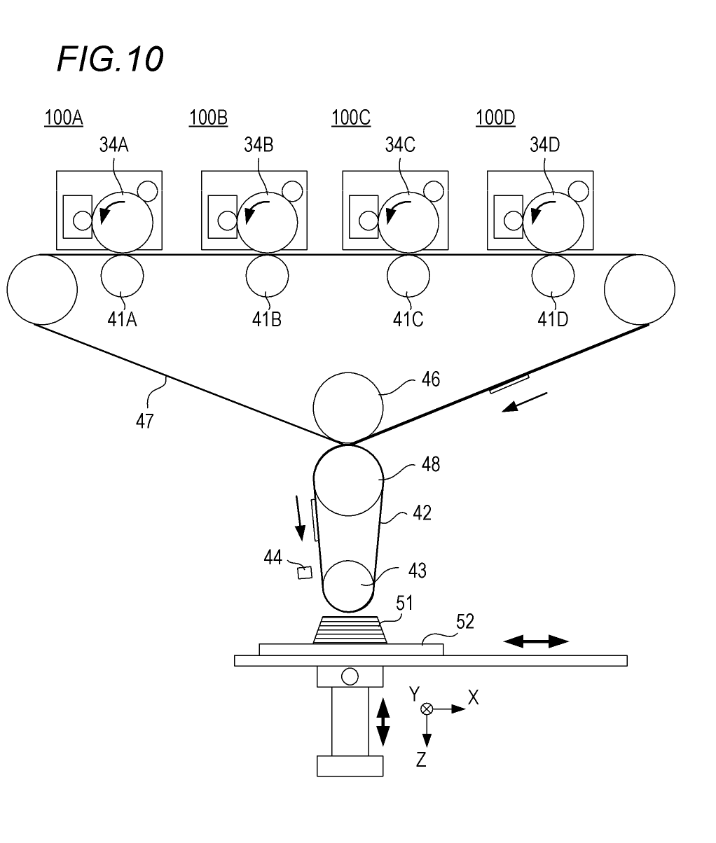

FIG. 10 is a diagram depicting a configuration of a three-dimensional shaping apparatus according to Embodiment 3 of the present invention. The difference from Embodiment 1 is that four image forming units 100A to 100D are included, and the transfer member is separated into a primary transfer member 47 for image formation, and a secondary transfer member 42 for lamination. An advantage of the configuration where a plurality of image forming units 100A to 100D are disposed is that this allows shaping using a plurality of types of materials, the use of different materials by selection, coloring the shaped object and the like, as in Embodiment 2. One advantage of the configuration having a plurality of transfer members 47 and 42 is that the transfer belt technology, which is standard in the 2-D printer and copier fields, can be utilized. Furthermore, separating the transfer members can increase flexibility in selecting materials of each transfer member, and improve the functions of each transfer member, such as using a material having superb transfer characteristics for the primary transfer member 47, and using a material having superb heat resistance for the secondary transfer member 42.

The three-dimensional shaping apparatus includes photosensitive drums 34A, 34B, 34C and 34D, transfer rollers 41A, 41B, 41C and 41D, primary transfer member 47 and transfer roller pair 46 and 48. A material image formed by each image forming unit 100A to 100D is sequentially transferred from the photosensitive drums 34A to 34D onto the primary transfer member 47. The material images on the primary transfer member 47 are transferred to the secondary transfer member 42 by the transition roller pair 46 and 48. The material images on the secondary transfer member 42 are conveyed to the shaping unit, and are laminated on the stage 52 or on the semi-shaped object on the stage 52. In this configuration, it is preferable to execute the offline calibration for each image forming unit 100A to 100D respectively, so that the image distortion in each image forming unit 100A to 100D is corrected.

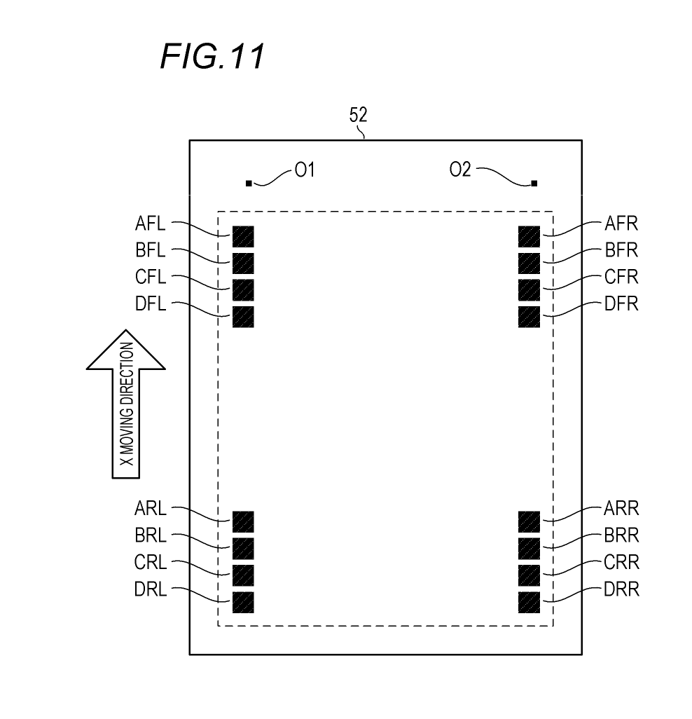

FIG. 11 is an example of the calibration markers used in this embodiment. As the markers for the image forming unit 100A, a front left end calibration marker AFL, a front right end calibration marker AFR, a rear left end calibration marker ARL and a rear right end calibration marker ARR are generated. In the same manner, as markers for the image forming unit 100B, a front left end calibration marker BFL, a front right end calibration marker BFR, a rear left end calibration marker BRL, and a rear right end calibration marker BRR are generated. As markers for the image forming unit 100C, a front left end calibration marker CFL, a front right end calibration marker CFR, a rear left end calibration marker CRL, and a rear right end calibration marker CRR are generated. As markers for the image forming unit 100D, a front left end calibration marker DFL, a front right end calibration marker DFR, a rear left end calibration marker DRL and a rear right end calibration marker DRR are generated. Each marker is generated so as not to overlap with other markers.

As in Embodiment 1, a deformation vector of each marker is calculated, whereby image distortion information of the image formed by each of the image forming units 100A to 100D can be acquired. This allows independent correction of the image distortion generated in an image formed by each of the image forming units 100A to 100D, hence a shaped object having excellent dimensional accuracy and shape accuracy can be acquired.

As an operation method of Embodiment 3, it is assumed that the image forming unit 100B stands by as a spare for the image forming unit 100A, and the image forming unit 100A switches to the image forming unit 100B when the material in the image forming unit 100A empties. In this case, it is preferable that the correction parameters of the image forming units 100A and 100B are created and stored in advance respectively. Then when the image forming unit to be used is switched from 100A to 100B, the correction parameters for the image forming unit 100A can be switched immediately to the correction parameters for the image forming unit 100B. This makes any procedure, such as exchanging cartridges and calibration, unnecessary, and lamination shaping can be automatically continued at high precision.

In this embodiment as well, as in Embodiment 2, if image distortion generated in the image forming units 100A to 100D is small, in terms of scanning accuracy in exposure and dimensional accuracy of the photosensitive drum and the like, then the image distortion information acquired by the offline calibration using one of the image forming units 100A to 100D may be used for the image distortion correction upon forming a material image in the image forming units 100A to 100D.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-104681, filed on May 22, 2015, which is hereby incorporated by reference herein in its entirety.

What is claimed is:

1. A three-dimensional shaping apparatus, comprising:
an image forming unit configured to form a material image formed from a shaping material based on input image data;
a transfer member to which the material image formed by the image forming unit is transferred and which is configured to convey the material image; and
a stage on which the material image conveyed by the transfer member is laminated,
the three-dimensional shaping apparatus comprising:
a marker generation unit configured to generate image data of a calibration marker;
a control unit configured to input the generated image data of the calibration marker to the image forming unit;
a first detection unit configured to detect a position of the calibration marker, which is formed by the image forming unit based on the image data of the calibration marker and laminated on the stage; and
an image distortion measurement unit configured to measure image distortion of the calibration marker laminated on the stage, based on the detection result from the first detection unit.

2. The three-dimensional shaping apparatus according to claim 1, wherein
the control unit includes a correction unit configured to perform correction to reduce the image distortion on the image data input to the image forming unit, based on the image distortion measured by the image distortion measurement unit.

3. The three-dimensional shaping apparatus according to claim 1, wherein
the image distortion measurement unit determines, as the image distortion, a deformation vector calculated based on a difference between the position of the calibration marker detected by the first detection unit and normal position where the calibration marker is to be laminated when there is no image distortion.

4. The three-dimensional shaping apparatus according to claim 1, wherein
the calibration marker include a plurality of markers disposed within a shaping area on the stage, at positions distant from one another.

5. The three-dimensional shaping apparatus according to claim 1, wherein
the calibration marker include a plurality of markers disposed on four corners of a rectangular shaping area on the stage.

6. The three-dimensional shaping apparatus according to claim 4, wherein
the image distortion measurement unit calculates the image distortion at a position where material images of the plurality of markers are not formed within the shaping area, using linear interpolation of the image distortion of the plurality of markers.

7. The three-dimensional shaping apparatus according to claim 1, comprising a plurality of image forming units, wherein
the marker generation unit generates image data of calibration markers for the plurality of image forming units respectively, and
the first detection unit detects the calibration markers and the image distortion measurement unit measures the image distortion, for the plurality of image forming units respectively.

8. The three-dimensional shaping apparatus according to claim 1, wherein
the control unit includes a marker attaching unit configured to attach image data of a registration marker to slice image data to be input to the image forming unit, and
the three-dimensional shaping apparatus further comprises:
a second detection unit configured to detect the registration marker on the transfer member;
a position measurement unit configured to measure a positional shift of a material image based on the slice image data on the transfer member, using the detection result from the second detection unit; and
an adjustment unit configured to adjust a position of the stage based on the positional shift measured by the position measurement unit, when the material image based on the slice image data on the transfer member is laminated.

9. The three-dimensional shaping apparatus according to claim 8, wherein
the registration marker is a graphic having a first edge which is orthogonal to an advancing direction of the transfer member and a second edge which is diagonal with respect to the advancing direction of the transfer member, and
the position measurement unit:
acquires a position of the material image with respect to the advancing direction of the transfer member, based on a detection timing of the first edge; and
acquires the positional shift of the material image with respect to the direction orthogonal to the advancing direction of the transfer member, based on a difference between the detection timing of the first edge and a detection timing of the second edge.

10. The three-dimensional shaping apparatus according to claim 1, wherein
the transfer member includes a primary transfer member to which the material image is transferred from the image forming unit, and a second transfer member to which the material image is transferred from the primary transfer member and which is configured to convey the material image to a lamination position on the stage.

11. The three-dimensional shaping apparatus according to claim 1, wherein
the image forming unit forms the material image by an electrophotographic process.

12. A three-dimensional shaping apparatus, comprising:
an image forming unit configured to form a material image formed from a shaping material based on input image data;
a transfer member to which the material image formed by the image forming unit is transferred and which is configured to convey the material image; and
a stage on which the material image conveyed by the transfer member is laminated,
the three-dimensional shaping apparatus comprising:
a control unit configured to generate slice image data including a slice image of a shaping target object and a registration marker, and to input the slice image data to the image forming unit;
a second detection unit configured to detect the registration marker, which are formed by the image forming unit based on the slice image data and are included in the material image transferred to the transfer member;
a position measurement unit configured to measure a positional shift of the material image on the transfer member based on the detection result from the second detection unit; and
an adjustment unit configured to adjust a position of the stage based on the positional shift measured by the position measurement unit.

13. The three-dimensional shaping apparatus according to claim 12, wherein
the registration marker is a graphic having a first edge which is orthogonal to an advancing direction of the transfer member and a second edge which is diagonal with respect to the advancing direction of the transfer member, and
the position measurement unit:
acquires a position of the material image with respect to the advancing direction of the transfer member, based on a detection timing of the first edge; and
acquires the positional shift of the material image with respect to the direction orthogonal to the advancing direction of the transfer member, based on a difference between the detection timing of the first edge and a detection timing of the second edge.

14. The three-dimensional shaping apparatus according to claim 12, wherein
the transfer member includes a primary transfer member to which the material image is transferred from the image forming unit, and a second transfer member to which the material image is transferred from the primary transfer member and which is configured to convey the material image to a lamination position on the stage.

15. The three-dimensional shaping apparatus according to claim 12, wherein
the image forming unit forms the material image by an electrophotographic process.

16. A lamination shaping method for shaping a three-dimensional object by forming a material image formed from a shaping material based on image data and laminating the material image on a stage,
the lamination shaping method comprising the steps of:
forming a calibration marker formed from the shaping material;
laminating the calibration marker on the stage;
detecting a position of the calibration marker laminated on the stage; and
acquiring image distortion information on image distortion generated in the material image based on the position of the calibration marker.

17. The lamination shaping method according to claim 16, further comprising a step of performing correction to reduce the image distortion on the image data based on the image distortion information.

18. The lamination shaping method according to claim 16, further comprising the steps of:
generating slice image data including a slice image of a shaping target object and a registration marker;
performing correction to reduce the image distortion on the slice image data based on the image distortion information;
forming a material image based on the slice image data; and
detecting a position of the registration marker included in the material image and adjusting a relative position between the material image and the stage.

19. A lamination shaping method for forming a three-dimensional object by forming a material image formed from a shaping material and laminating the material image on a stage, the lamination shaping method comprising the steps of:
generating slice image data including a slice image of a shaping target object and a registration marker;
forming the material image based on the slice image data; and
detecting a position of the registration marker included in the material image and adjusting a relative position between the material image and the stage.
